(19) United States
(12) Patent Application Publication
(10) Pub. No.: US 2003/0111557 A1
(43) Pub. Date: Jun. 19, 2003

(54) Fuel injection valve

(76) Inventors: Franz Rieger, Aalen (DE); Thomas Ludwig, Huenxe (DE); Hans Schlembach, Muehlacker (DE); Gottlob Haag, Markgroeningen (DE); Ulrich Brenner, Moeglingen (DE); Michael Huebel, Gerlingen (DE); Juergen Stein, Illingen (DE); Udo Sieber, Bietigheim (DE)

Correspondence Address: KENYON & KENYON, ONE BROADWAY, NEW YORK, NY, 10004, US

(21) Appl. No.: 10/182,588

(22) PCT Filed: Nov. 30, 2001
(86) PCT No.: PCT/DE01/04506

(30) Foreign Application Priority Data
Dec. 5, 2000 (DE) 100 60 435.8

(51) Int. Cl. F02M 59/00; F02M 61/00; B05B 1/30

(52) U.S. Cl. 239/533.2; 239/585.1

(57) ABSTRACT

A fuel injection valve, in particular for direct injection of fuel into a combustion chamber of an internal combustion engine, includes an actuator that is in working engagement with a valve needle, the valve needle including at its spray-discharge end a valve closure element that coacts with a valve seating surface configured on a valve seat element to form a sealing seat. Also provided is a swirl disk in which swirl channels are configured. The swirl disk includes extensions that coact with a cam disk in such a manner that a tangential component of the swirl generated by the swirl disk is modifiable.

### FIELD OF THE INVENTION

The present invention relates to a fuel injection valve.

### BACKGROUND INFORMATION

German Published Patent Application No. 197 36 682 discusses a fuel injection valve, for direct injection of fuel into the combustion chamber of a mixture-compressing, spark-ignited internal combustion engine, which includes at the downstream end of the fuel injection valve a guidance and seating region that is constituted by three disk-shaped elements. A swirl element is embedded between a guidance element and a valve seating element. The guidance element serves to guide an axially movable valve needle that projects through it, while a valve closure segment of the valve needle coacts with a valve seating surface of the valve seating element. The swirl element includes an inner opening region including multiple swirl channels that are not joined to the outer periphery of the swirl element. The entire opening region extends completely over the axial thickness of the swirl element.

German Published Patent Application No. 197 36 682 discusses a fuel injection valve with a permanently adjusted swirl angle, which may not be adapted to the differing operating states (such as partial- and full-load operation) of an internal combustion engine. As a result, the conical opening angle α of the injected mixture cloud also may not be adapted to the differing operating states, resulting in inhomogeneities in combustion, elevated fuel consumption, and elevated exhaust emissions.

### SUMMARY OF THE INVENTION

The exemplary fuel injection valve according to the present invention may provide that the swirl may be adjusted as a function of the operating state of the fuel injection valve, so that a spray pattern adapted to the operating state of the fuel injection valve may be produced. Both mixture preparation and combustion characteristics may thereby be optimized.

The construction of the swirl-generating components may be useful, which as compared to the known swirl preparation system need to be supplemented only with an easily manufactured cam disk.

It may be useful that the extensions whose protrusions coact with the cam disk are integrally joined flexibly to the swirl disk. The swirl disk may easily be manufactured, for example, by stamping from a metal foil.

The cam disk may be shaped so that the extensions of the swirl disk are adjustable steplessly within a selectable angular range. As a result, any desired swirl angle may be set.

The cam disk may be adjustable by manner of the rotatably mounted valve needle. The valve needle rotation may be excited by a control unit above the valve group.

The assembly and the capability of using very largely standard components may also be useful.

Exemplary embodiments of the present invention are shown in the drawings, and will be explained in the description below.

### BRIEF DESCRIPTION OF THE DRAWINGS

FIG. 1 shows a schematic section through an exemplary embodiment of a fuel injection valve according to the present invention.

FIG. 2 shows a schematic section, in region II of FIG. 1, through the spray-discharge end of the exemplary fuel injection valve according to the present invention shown in FIG. 1.

FIG. 3A schematically shows the spray angle α generated by the exemplary fuel injection valve configured according to the present invention, in different operating states of the exemplary fuel injection valve according to the present invention.

FIG. 3B schematically shows the spray angle α generated by the exemplary fuel injection valve configured according to the present invention, in different operating states of the exemplary fuel injection valve according to the present invention.

FIG. 4 shows a schematic, partially sectioned view of a first exemplary embodiment of the swirl-generating components of the exemplary fuel injection valve according to the present invention.

FIG. 5A shows a schematic, partially sectioned view of a second exemplary embodiment of the swirl-generating components in different operating states of the exemplary fuel injection valve according to the present invention.

FIG. 5B shows a schematic, partially sectioned view of a second exemplary embodiment of the swirl-generating components in different operating states of the exemplary fuel injection valve according to the present invention.

### DETAILED DESCRIPTION

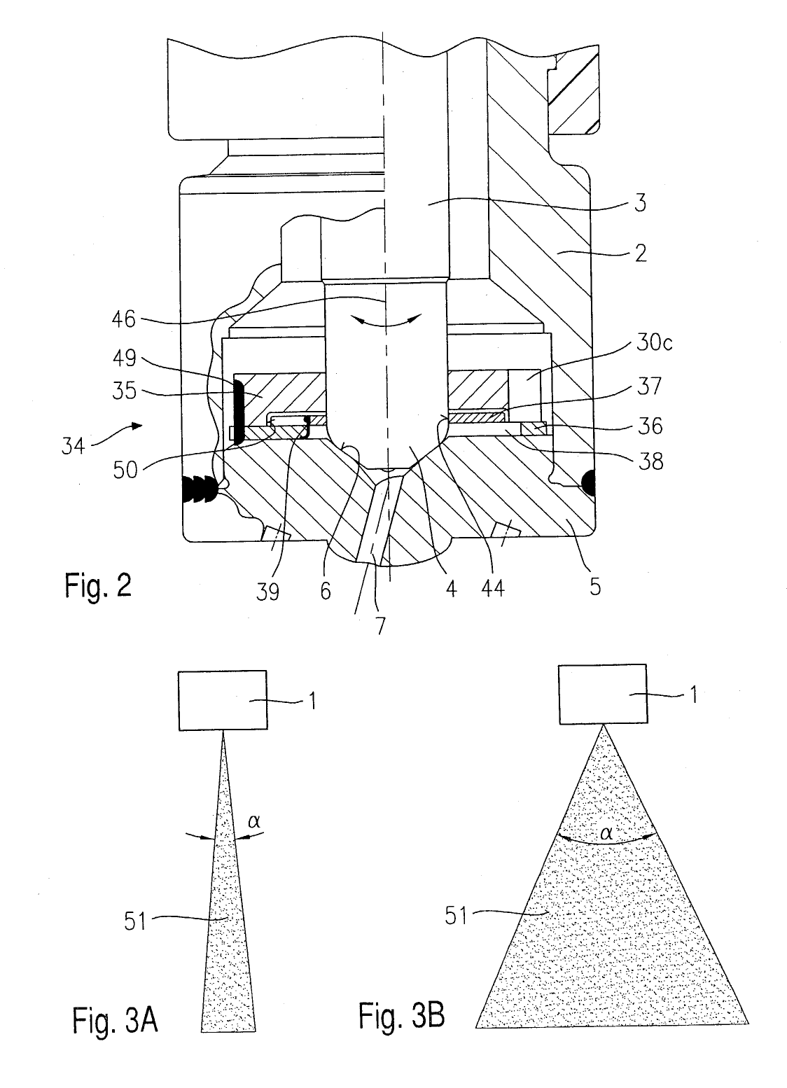

Before a detailed description is given of exemplary embodiments of a fuel injection valve 1 according to the present invention with reference to FIGS. 2 through 5, the exemplary fuel injection valve 1 according to the present invention will first, for better comprehension of the present invention, be explained briefly in an overall presentation in terms of its constituents.

Fuel injection valve 1 is embodied in the form of a fuel injection valve 1 for fuel injection systems of mixture-compressing, spark-ignited internal combustion engines. Fuel injection valve 1 is suitable in particular for direct injection of fuel into a combustion chamber (not shown) of an internal combustion engine.

Fuel injection valve 1 comprises a nozzle body 2 in which a valve needle 3 is arranged. Valve needle 3 is in working engagement with a valve closure element 4 which coacts with a valve seating surface 6, arranged on a valve seat element 5, to form a sealing seat. In the exemplary embodiment, fuel injection valve 1 is an inward-opening fuel injection valve 1 that possesses a spray discharge opening 7. Nozzle body 2 is sealed by a seal 8 with respect to external pole 9 of a magnet coil 10. Magnet coil 10 is encapsulated in a coil housing 11 and wound onto a coil support 12 that rests on an internal pole 13 of magnet coil 10. Internal pole 13 and external pole 9 are separated from one another by a gap 26, and are supported on a connecting component 29. Magnet coil 10 is energized, via a conductor 19, by an electrical current that may be conveyed via an electrical plug contact 17. Plug contact 17 is surrounded by a plastic sheath 18 that may be injection-molded onto internal pole 13.

Valve needle 3 is guided in a valve needle guide 14 of disk-shaped configuration. A paired adjusting disk 15 serves to adjust the linear stroke. Located on the other side of adjusting disk 15 is an armature 20. The latter is joined nonpositively via a first flange 21 to valve needle 3, which is joined to first flange 21 by manner of a weld seam 22. Braced against first flange 21 is a return spring 23 which, in the present configuration of fuel injection valve 1, is preloaded by a sleeve 24.

A second flange 31, which is joined to valve needle 3 via a weld seam 33, serves as the lower armature stop. A flexible spacer ring 32 that rests on second flange 31 prevents bouncing upon closure of fuel injection valve 1.

A swirl element 34 made up of a guidance disk 35, a swirl disk 36, and a cam disk 37 is arranged on the inlet side of the sealing seat. Swirl element 34 provides a swirl preparation of the fuel stream that depends on the operating state of fuel injection valve 1. In partial-load operation, the fuel flowing through fuel injection valve 1 receives less of a swirl, resulting in a small stream opening angle α, whereas in full-load operation, a larger stream opening angle α may also be obtained by manner of a greater swirl. The mixture may correspondingly be made richer or leaner, so that optimum combustion may be achieved. Swirl element 34 and its manner of operation are explained in FIGS. 2 through 5.

Fuel conduits 30a through 30c extend in valve needle guide 14, in armature 20, and in guidance disk 35. Fuel is conveyed through a central fuel inlet 16 and filtered through a filter element 25. Fuel injection valve 1 is sealed by manner of a seal 28 with respect to a fuel line (not shown).

When fuel injection valve 1 is in the idle state, armature 20 is impinged upon opposite to its linear stroke direction by return spring 23 so that valve closure element 4 is held in sealing contact against valve seating surface 6. Upon energization of magnet coil 10, the latter establishes a magnetic field that moves armature 20 in the linear stroke direction against the spring force of return spring 23, the linear stroke is defined by a working gap 27 present between internal pole 13 and armature 20. Armature 20 also entrains flange 21, which is welded to valve needle 3, in the linear stroke direction. Valve closure element 4 that is in working engagement with valve needle 3 lifts off from valve seating surface 6, and the fuel is discharged.

When the coil current is shut off and once the magnetic field has decayed sufficiently, armature 20 falls away from internal pole 13 as a result of the pressure of return spring 23, thereby moving flange 21, which is in working engagement with valve needle 3, against the linear stroke direction. Valve needle 3 is thereby moved in the same direction, so that valve closure element 4 settles onto valve seating surface 6 and fuel injection valve 1 is closed.

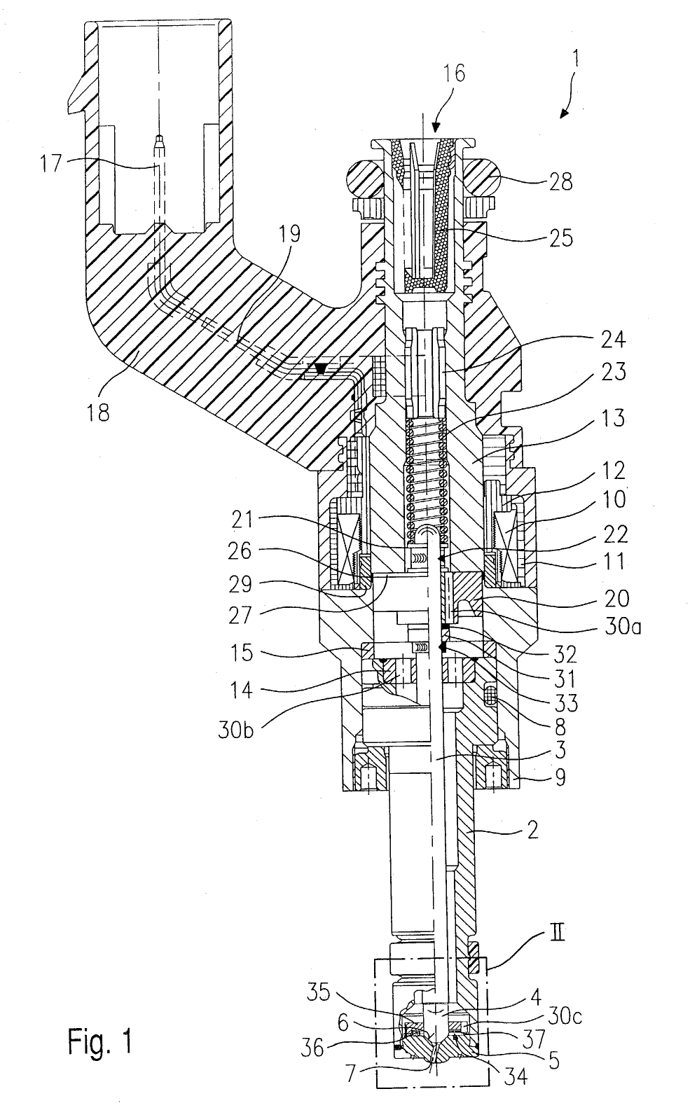

FIG. 2 shows, in an enlarged illustration, a portion of the spray-discharge end of an exemplary fuel injection valve 1 configured according to the present invention that is shown in FIG. 1. The portion is labeled II in FIG. 1. Identical components are given matching reference characters.

Swirl element 34, which is made up of guidance disk 35, swirl disk 36, and cam disk 37 that is arranged between swirl disk 36 and guidance disk 35, includes the rotatably mounted valve needle 3 passing through it. Cam disk 37 is arranged in an outflow-side recess 50 of guidance disk 35 and is joined positively and nonpositively to valve needle 3. Guidance disk 35 and swirl disk 36 are joined to one another and to valve seat element 5 by manner of a weld seam 49.

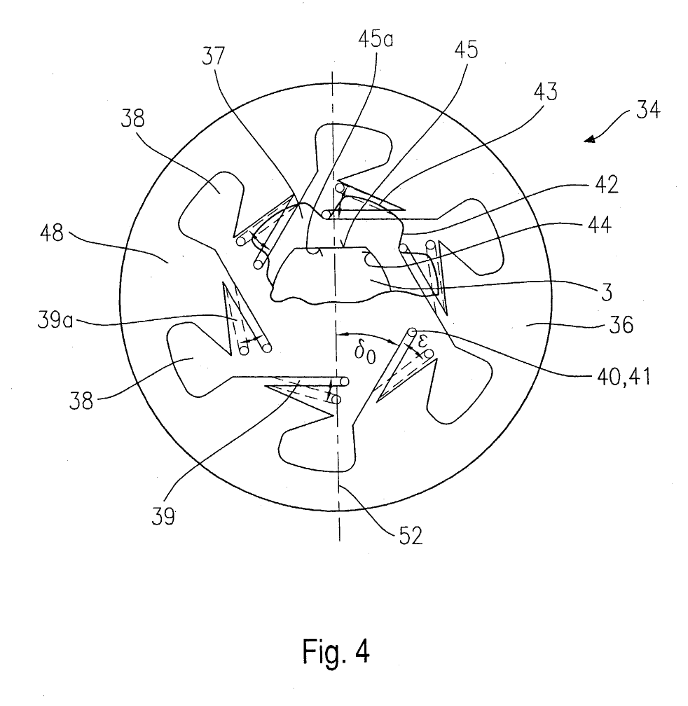

Guidance disk 35 conveys the inflowing fuel through fuel conduit 30c to swirl disk 36, which includes swirl channels 38. As a result, the fuel is directed so that it flows through swirl disk 36 from radially outward to radially inward, receiving a swirl that depends on a swirl angle δ which is discussed in further detail in the description of FIG. 4. The fuel flows out of swirl channels 38 to the sealing seat and is injected through spray discharge opening 7 into the combustion chamber (not shown) of an internal combustion engine. An opening angle α of the conical mixture cloud injected into the combustion chamber depends on the swirl and thus on swirl angle δ.

FIGS. 3A and 3B show, in a highly schematic illustration, two mixture clouds 51 that, in different operating states of fuel injection valve 1, guarantee a stoichiometric mixture distribution and thus optimal combustion.

FIG. 3A shows mixture cloud 51 that must be injected by fuel injection valve 1 under partial load. Conical opening angle α here is relatively small; in the present example it is 11 degrees. The result is that under partial load, mixture cloud 51 is somewhat richer; thus only a portion of the combustion chamber is filled with an ignitable fuel-air mixture, while the rest of the combustion chamber is filled with a lean mixture.

In contrast to this, FIG. 3B shows a mixture cloud 51 that is required for full-load operation. Here conical opening angle α is considerably greater; in the present example it is approx. 48 degrees. As a result of this large opening angle, the injected fuel is distributed uniformly in the entire combustion chamber volume so that under full load, the entire contents of the combustion chamber are available for combustion.

FIG. 4 shows a schematic plan view of swirl disk 36 as well as a schematic partial section of cam disk 37 of a first exemplary embodiment of fuel injection valve 1 configured according to the present invention. Swirl disk 36 is shown in its entirety, while for easier orientation only a portion of cam disk 37 is shown.

Swirl disk 36 is made up of a main body 48 and a number of extensions 39 that, in the present exemplary embodiment, are configured integrally with main body 48 of swirl disk 36, for example by being stamped out. In the present exemplary embodiment, the number of extensions 39 is six.

In a minimum state that corresponds to the partial-load state of the internal combustion engine, upwardly bent protrusions 41 that are configured at ends 40 of extensions 39 engage into indentations 42 of cam disk 37. The result is to define an initial swirl angle δ0 that is between 0 and 45 degrees and imparts to the fuel a swirl which is sufficient to generate an opening angle α of mixture cloud 51 injected into the combustion chamber as shown in FIG. 3A.

If the operating state changes because the internal combustion engine transitions into the full-load state, the small opening angle α is, as described above, no longer sufficient. To widen opening angle α, swirl angle δ must also be widened. This is achieved by the fact that cam disk 37 is rotated in its position relative to extensions 39, so that extensions 39 are pushed radially outward over a selectable displacement angle ε. As a result, the initial swirl angle δ0 is widened by an amount equal to displacement angle ε, thereby moving the fuel curve in swirl disk 36 radially outward and thus widening opening angle α. Displacement angle ε is between 0 and 30 degrees. Swirl angle δ thus varies within an angular range of 0 to 75 degrees.

Extensions 39a shown with dashed lines represent the maximum position for full-load operation of the internal combustion engine. For that purpose, cam disk 37 is rotated by manner of valve needle 3, which is rotatably mounted and may be controlled by a control unit (not shown). To ensure a positive and nonpositive connection between valve needle 3 and cam disk 37, valve needle 3 includes on at least one side a flattened area 45 that coacts with a corresponding structure 45a of cam disk 37. Upon rotation of valve needle 3, cam disk 37 is thereby entrained and thus rotated in its position with respect to extensions 39.

Cam disk 37 not only may have a sawtooth profile as in the present first exemplary embodiment, but also may be embodied in many different manners, for example with steps or smaller and larger indentations 42, in order to meet requirements in terms of the injected mixture cloud 51 in various operating states of the internal combustion engine.

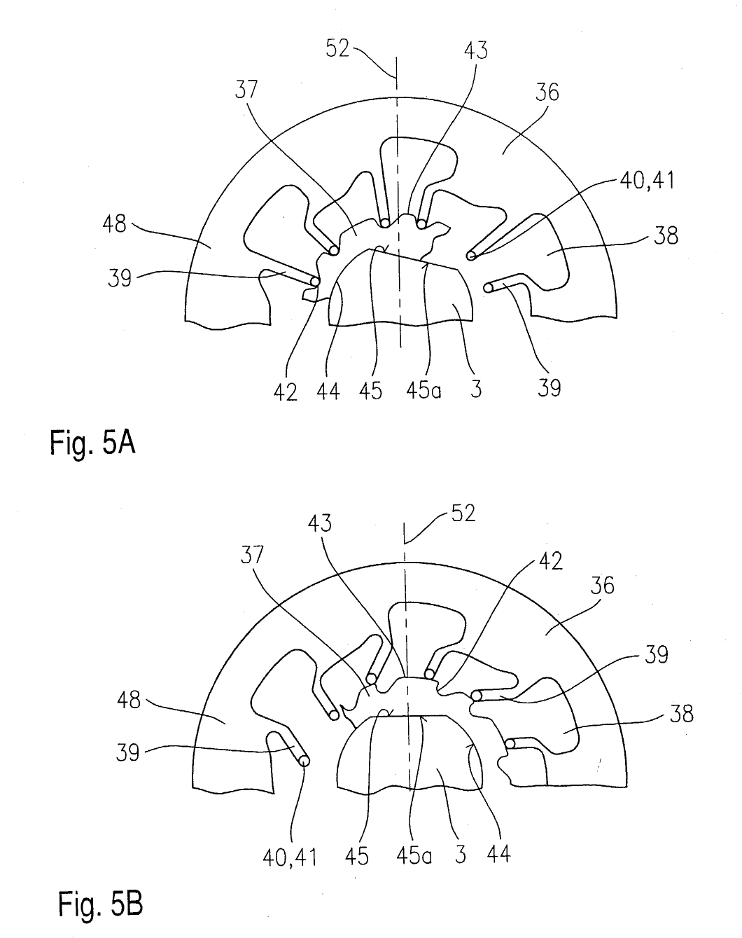

FIGS. 5A and 5B show, in a partial plan view and sectioned view, a further exemplary embodiment of a fuel injection valve according to the present invention in two different operating states of the internal combustion engine.

FIG. 5A shows the position for partial-load operation. Extensions 39, which in the present second exemplary embodiment are configured on either side of each swirl channel 38, engage with their projecting protrusions 41 into indentations 42 of cam disk 37. The initial swirl angle δ0 and swirl angle δ are almost 0 degrees, so that the fuel flowing through swirl disk 36 is discharged with almost no swirl.

In the present exemplary embodiment, the radial lengths of swirl channels 38 are different, every second swirl channel 38 is somewhat shorter than the others; the result is that the strandedness and stoichiometry of mixture cloud 51 may be modeled.

FIG. 5B shows, using the same view as FIG. 5A, the position suitable for full-load operation. Extensions 39 rest with their projecting protrusions 41 against outer rim 43 of cam disk 37. Displacement angle ε and swirl angle δ are thereby widened, so that the fuel flowing through swirl disk 36 is discharged with a swirl that results in a widening of opening angle α of mixture cloud 51.

The present invention is not limited to the exemplary embodiments shown, and is also suitable, for example, for multiple-orifice fuel injection valves 1, for fuel injection valves 1 including any kind of actuators 10, or for swirl disks 36 including a different number and orientation of swirl channels 38.

What is claimed is:

1. A fuel injection valve (1), in particular for direct injection of fuel into a combustion chamber of an internal combustion engine, having an actuator (10) that is in working engagement with a valve needle (3), the valve needle (3) having at its spray-discharge end a valve closure element (4) that coacts with a valve seating surface (6) configured on a valve seat element (5) to form a sealing seat, and having a swirl disk (36) in which swirl channels (38) are configured; wherein the swirl disk (36) has extensions (39) that coact with a cam disk (37) in such a way that a tangential component of the swirl generated by the swirl disk (36) is modifiable.

2. The fuel injection valve as defined in claim 1, wherein the extensions (39) are joined flexibly to a main body (48) of the swirl disk (36).

3. The fuel injection valve as defined in claim 1 or 2, wherein the extensions (39) have protrusions (41) at their ends (40).

4. The fuel injection valve as defined in claim 3, wherein the cam disk (37) has indentations (42) on an outer rim (43).

5. The fuel injection valve as defined in claim 4, wherein the protrusions (41) of the extensions (39) engage into the indentations (42) of the cam disk (37).

6. The fuel injection valve as defined in one of claims 1 through 5, wherein the valve needle (3) passes through the cam disk (37) through a recess (44) of the cam disk (37).

7. The fuel injection valve as defined in one of claims 1 through 6, wherein the valve needle (3) is joined positively and nonpositively to the cam disk (37).

8. The fuel injection valve as defined in claim 7, wherein for nonpositive joining to the cam disk (37), the valve needle (3) has a flattened area (45) on at least one side.

9. The fuel injection valve as defined in claim 5, wherein the valve needle (3) is rotatable about a longitudinal axis (46) of the valve needle (3).

10. The fuel injection valve as defined in claim 9, wherein by rotation of the valve needle (3), the cam disk (37) is movable into various positions relative to the position of the extensions (39).

11. The fuel injection valve as defined in claim 10, wherein in a minimum position with the fuel injection valve (1) in partial-load operation, the projections (41) at the ends (40) of the extensions (39) engage into the indentations (42) of the cam disk (37).

12. The fuel injection valve as defined in claim 11, wherein in a maximum position with the fuel injection valve (1) in full-load operation, the projections (41) at the ends (40) of the extensions (39) rest against the outer rim (43) of the cam disk (37).

13. The fuel injection valve as defined in claim 11 or 12, wherein an opening angle (α) of a mixture cloud injected into the combustion chamber is smaller in the minimum position than in the maximum position.

14. The fuel injection valve as defined in claim 11 or 12, wherein a displacement angle (ε) between the minimum position and maximum position of the extensions (39) is between 0 and 30 degrees.

15. The fuel injection valve as defined in one of claims 1 through 14, wherein in the minimum position, the extensions (39) enclose an initial swirl angle (δ₀) with an axis (47) of the swirl channels (38).

16. The fuel injection valve as defined in claim 15, wherein in the minimum position, the initial swirl angle (δ₀) is between 0 and 45 degrees.

17. The fuel injection valve as defined in claim 16, wherein the sum of the initial swirl angle (δ₀) and the displacement angle (ε) yields a total swirl angle (δ), and the total swirl angle (δ) lies in an angular range of 0 to 75 degrees.
